(19) United States
(12) Patent Application Publication
(10) Pub. No.: US 2017/0018878 A1
(43) Pub. Date: Jan. 19, 2017

(54) LOCKING DEVICE FOR ONE OR MORE DATA PORTS

(71) Applicants: David Coccimiglio, Sandy, UT (US); F. Trace Coccimiglio, Sandy, UT (US)

(72) Inventors: David Coccimiglio, Sandy, UT (US); F. Trace Coccimiglio, Sandy, UT (US)

(21) Appl. No.: 15/159,635

(22) Filed: May 19, 2016

Related U.S. Application Data
(60) Provisional application No. 62/164,229, filed on May 20, 2015.

(51) Int. Cl. H01R 13/639; H01R 25/00; H01R 24/62

(52) U.S. Cl. CPC H01R 13/6397; H01R 24/62; H01R 25/006; H01R 2107/00

(57) ABSTRACT

A locking device for one or more data ports, each data port comprising a female jack configured to receive and provide an electrical connection for a male connector. The locking device comprising a locking member comprising one or more retention prongs, wherein the locking member is configured to move between an unlocked position and a locked position, each of the one or more retention prongs extend through a corresponding aperture disposed in a female jack of the one or more data ports when the locking member is in the locked position, and when one of the male connectors is inserted into the corresponding female jack, at least one of the one or more retention prongs extend through an aperture disposed in the male connector and the aperture disposed in the corresponding female jack when the locking member is in the locked position such that the male connector cannot be removed from the corresponding female jack.

### TECHNICAL FIELD

This application relates to systems and methods for a locking device.

### BRIEF DESCRIPTION OF THE DRAWINGS

FIG. 1A is a diagram of a locking device for a data port according to one embodiment.

FIG. 1B is a diagram of a locking device for a data port according to one embodiment.

FIG. 2 is a diagram of a locking device for a data port according to one embodiment.

FIG. 3 is a diagram of a male USB port according to one embodiment.

FIG. 4 is a diagram of a locking device for two or more data ports according to one embodiment.

FIG. 5 is a diagram of a locking device for two or more data ports according to one embodiment.

FIG. 6 is a diagram of a locking device for two or more data ports according to one embodiment.

FIG. 7 is a diagram of a locking device for two or more data ports according to one embodiment.

FIG. 8 is a diagram of a locking device for two or more data ports according to one embodiment.

### DETAILED DESCRIPTION OF PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present disclosure provides systems and methods for a locking device for one or more data ports, each data port comprising a female jack configured to receive and provide an electrical connection for a male connector. The locking device comprising a locking member comprising one or more retention prongs, wherein the locking member is configured to move between an unlocked position and a locked position, each of the one or more retention prongs extend through a corresponding aperture disposed in a female jack of the one or more data ports when the locking member is in the locked position, and when one of the male connectors is inserted into the corresponding female jack, at least one of the one or more retention prongs extend through an aperture disposed in the male connector and the aperture disposed in the corresponding female jack when the locking member is in the locked position such that the male connector cannot be removed from the corresponding female jack.

In some embodiments, systems and methods for a locking device for two or more data ports comprise a bracket, a lock coupled to the bracket via the lock opening, and a locking member coupled to the lock. The bracket comprises a lock opening and at least two port openings. The lock is configured to move between an unlocked position and a locked position. The locking member includes a first number of retention prongs that extend through an aperture disposed in at least one of a first male connector and a first female jack if the lock is in the locked position, and a second number of retention prongs that extend through an aperture disposed in at least one of a second male connector and a second female jack when the lock is in the locked position. As used herein, a number can refer to one or more. As such, a first number of retention prongs may refer to one or more retention prongs.

In other embodiments, the locking device for two or more data ports comprises a bracket, a lock coupled to the bracket via the lock opening, a coupler coupled to the lock, and a locking member coupled to the lock via the coupler. The bracket comprises a lock opening and at least two port openings comprising at least a first female jack and a second female jack. The lock is configured to move between an unlocked position and a locked position. The coupler is configured to rotate within the lock. The locking member includes a coupler opening configured to make contact with the coupler and pivot on the coupler, a first number of retention prongs that extend through an aperture disposed in at least one of a first male connector and the first female jack when the lock is in the locked position, and a second number of retention prongs that extend through an aperture disposed in at least one of a second male connector and the second female jack when the lock is in the locked position.

Of growing concern to businesses, governments, and individuals is the need to secure data stored on computing devices. Threats to data on computing devices are presented by unauthorized use of a data interface. Data interfaces can include a data port. For example, a data interface can be a USB interface including a USB port. Some of the embodiments described herein may be provided in terms to USB interfaces and/or USB devices. Although USB interfaces and/or USB devices may be references, it is to be understood that the embodiments described herein are not limited to USB interfaces and/or USB devices but can incorporate data interfaces and devices configured to be coupled to the data interfaces.

The data interfaces can couple a device to a computing device. For example, a USB interface can couple a USB device to a computing device. A device can include keyboards, mice, printers, cameras, credit card readers, and/or many other devices that can be coupled to a computing device. The devices described herein can include USB devices. For example, a keyboard can be configured to be coupled to a USB port via a USB male connector of the keyboard.

Unauthorized access to the data interfaces using a logger device can lead to personal data being compromised. As used herein, a logger device can be a device configured to intercept data transferred between the data interface and a device coupled to the data interface via the logger device. The logger device can include hardware and/or computer readable instructions to intercept the data and/or store the data in the logger device and/or other devices coupled to the logger device.

Logger devices can be designed with a male connector (e.g., a male end) and/or a female jack (e.g., female end). As used herein, a female jack is a connector coupled to a wire, cable, and/or piece of hardware, having one or more recessed holes with electrical terminals inside, and constructed in such a way that a male connector can be inserted into the female jack to ensure a reliable physical and/or electrical connection.

A male connector is a connector attached to a wire, cable, and/or piece of hardware, having one or more exposed and/or unshielded electrical terminals, and constructed in such a way that it can be inserted into the female jack to ensure a reliable physical and/or electrical connection. A male connector may be referred to as a plug. A male connector can be recognized by the fact that, when it is disconnected or removed, the unshielded electrical terminals may be plainly visible.

Logger devices can be coupled (e.g., plugged) to data interfaces on the computing device and to a device, thereby enabling the logger devices to record data transferred from the data interface to the device and/or from the device to the data interface. For example, a logger device can intercept data typed on a keyboard and transferred to the computing device without a user of the computing device knowing that the logger device is present. Software solutions are currently not able to detect the presence of logger devices.

In previous approaches, USB locking devices may lock the USB interfaces, such that nothing can be coupled to the USB interfaces on which the USB locking devices are installed. The USB locking devices may disable the USB interfaces, making the USB interfaces unusable. The user of the computing device may utilize other ways of connecting a keyboard and/or other equipment in response to installing the USB locking device utilized in previous approaches, despite the fact that the vast majority of keyboards are designed to connect via USB interfaces.

The embodiments described herein utilize a hardware solution that secures the data interfaces on the computing device, while still allowing use of the data interfaces. The embodiments disclosed herein also allow a user to lock data interfaces with or without a device being coupled to the data interface. The disclosed embodiments secure the data interface while still allowing the data interfaces to be utilized. For example, a user of the computing device can couple a keyboard or any other device to the computing device via a data port of a locking device and lock the locking device. For example, the user can lock that device into the data port, therefore restricting the ability to utilize a logger device to be inserted between the device and the data port. The lock would have to be broken in order to install a logger device between the device and the data port.

The disclosed embodiments also improve the security of credit card information when it is transferred via a credit card reader (e.g., a USB credit card reader). Logging devices can capture information which is gathered during a credit card swipe transaction. Stealing the credit card data with a logger device can include uncoupling the credit card reader from the computing device, coupling the logging device to a data port of the computing device, and coupling the credit card reader to the logger device. The disclosed embodiments lock the credit card reader to the data port of the computing device so that the credit card cannot be removed without a key.

In some examples, data ports can be configured to secure the connection of a plug (e.g., USB plug) with springs which apply slight pressure to the male end of the plug, thereby preventing the plug from “falling out” and/or from accidentally pulling out of the plug. The ports have not been designed to prevent a plug from being disconnected by any person pulling on the cord.

In some embodiments, instead of applying slight pressure to secure a connection between a female jack and a male connector, one or more holes on the female jack can be used to insert a locking member into one or more holes on the male connector, thereby preventing the connection from being undone without use of a key to unlock the connection. As used herein the one or more holes may be referred to as one or more apertures.

The locking member may be spring loaded and/or manually slid to lock the male connector into place ensuring the male connector cannot be removed from the female jack. The locking member can then be secured into place and locked with a key and/or locking mechanism (e.g., locking device).

Embodiments may include various steps, which may be embodied in machine-executable instructions to be executed by a computer system. A computer system includes one or more general-purpose or special-purpose computers (or other electronic devices). The computer system may include hardware components that include specific logic for performing the steps or may include a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or “Internet” or IP networks, such as the World Wide Web, a private Internet, a secure Internet, a value-added network, a virtual private network, an extranet, an intranet, or even standalone machines which communicate with other machines by physical transport of media (a so-called “sneakernet”). In particular, a suitable network may be formed from parts or entireties of two or more other networks, including networks using disparate hardware and network communication technologies. The network may include a wireless network.

Each computer system includes at least a processor and a memory; computer systems may also include various input devices and/or output devices. The processor may include a general-purpose device, such as an Intel®, AMD®, or other “off-the-shelf” microprocessor. The processor may include a special-purpose processing device, such as an ASIC, a SoC, a SiP, an FPGA, a PAL, a PLA, an FPLA, a PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, a tape drive, an optical drive, a magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

Much of the infrastructure that can be used according to the present invention is already available, such as: general-purpose computers, computer programming tools and techniques, computer networks and networking technologies, digital storage media, authentication; access control, and other security tools and techniques provided by public keys, encryption, firewalls, and/or other means.

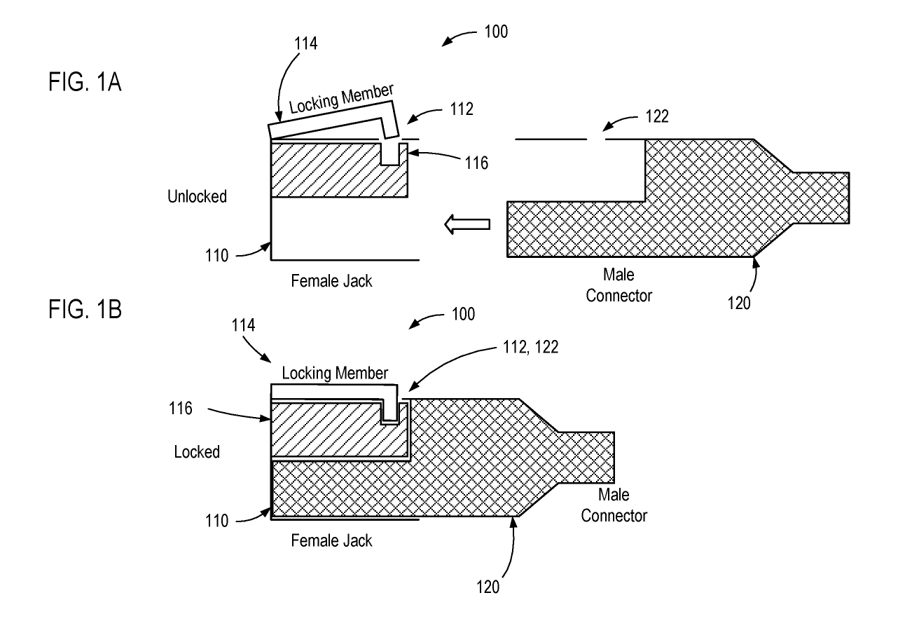

FIGS. 1A and 1B are diagrams of a locking device for a data port according to one embodiment. FIGS. 1A and 1B include a locking device 100. The locking device 100 includes a female jack 110 and a locking member 114. The female jack 110 includes at least one hole 112 and an inner portion 116. FIGS. 1A and 1B also include a male connector 120 including at least one hole 122.

FIG. 1A shows the locking device 100 in an unlocked configuration. FIG. 1B shows the locking device 100 in a locked configuration. FIG. 1A shows the male connector 120 being inserted into the female jack 110. FIG. 1B shows the male connector 120 coupled to the female jack 110. The male connector 120 is inserted into the female jack 110 through the inner portion 116 of the female jack 110.

The locking device 100 can be engage by inserting the locking member 114 through at least the hole 122 disposed in the male connector 120 of a data port, as shown in FIG. 1B. As used herein, a data port describes an interface between a device (e.g., a keyboard, a mouse, a camera, a credit card reader, among other possible devices) and a computing device. The locking member 114 can extend through at least the hole 112 in the female jack 110, continue through the hole 122 disposed in the male connector 120, and at least partially extend through an inner portion 116 of the female jack 110. As a result, the male connector 120 can be securely locked into the female jack 110. The removal of the male connector 120 from the female jack 110 can be prevented and may not be possible without deactivating the locking member 114. Deactivating the locking member 114 can include retrieving the locking member 114 from at least the hole 112 disposed in the female jack 110. Retrieving the locking member 114 may also include retrieving the locking member 114 from the hole 122 disposed in the male connector 120.

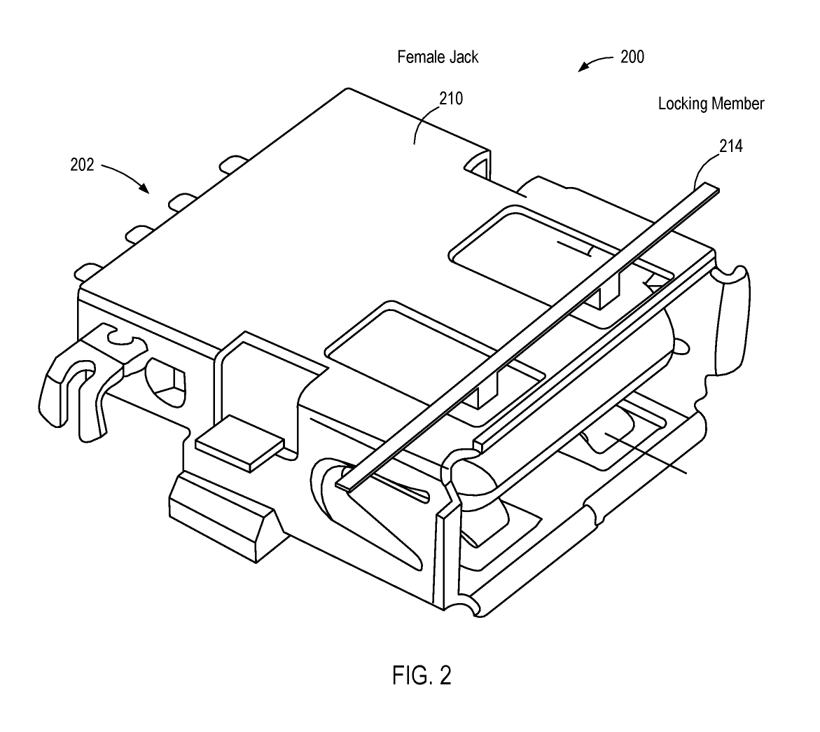

FIG. 2 is a diagram of a locking device for a data port according to one embodiment. FIG. 2 includes a locking device 200. The locking device 200, shown in FIG. 2, includes a female jack 210, a locking member 214, and a connector 202. As shown in FIG. 2, the female jack 210 is a USB female jack configured to be coupable to a USB male connector.

The connector 202 is hardware configured to couple the locking device 200 to a computing device. The connector 202 can be a male connector or a female jack, among other types of connectors 202 that can couple the locking device 200 to a computing device.

The locking member 214 can include a bar and/or one or more of prongs. The bar can be accessible by a user to insert the one or more prongs through one or more holes disposed in the female jack 210. That is, the locking member 214 can be configured to extend through one or more holes disposed in the female jack 210 and/or through one or more holes disposed in a male connector, when the male connector is coupled to the female jack 210.

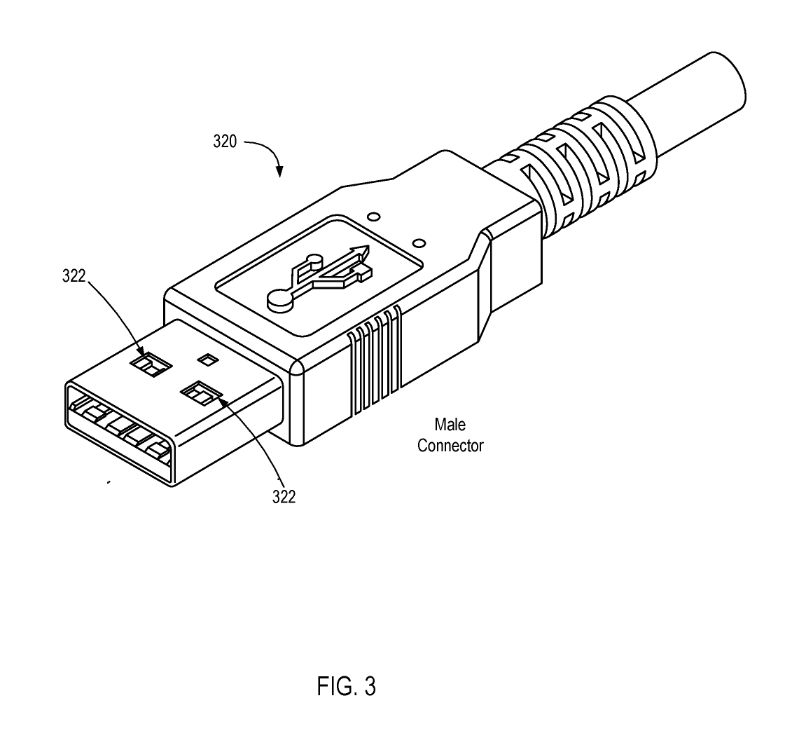

FIG. 3 is a diagram of a male USB port according to one embodiment. FIG. 3 includes a male connector 320. The male connector 320 shown in FIG. 3 includes two holes 322. In a number of other embodiments, the male connector 320 can include two or more holes. The male connector shown in FIG. 3 is a USB male connector.

Some embodiments of a locking device can utilize the at least one of the holes 322 disposed in the male connector 320 to secure the male connector 320 to the locking device. The locking device may secure the male connector 320 if the male connector 320 is coupled to a female jack of the locking device.

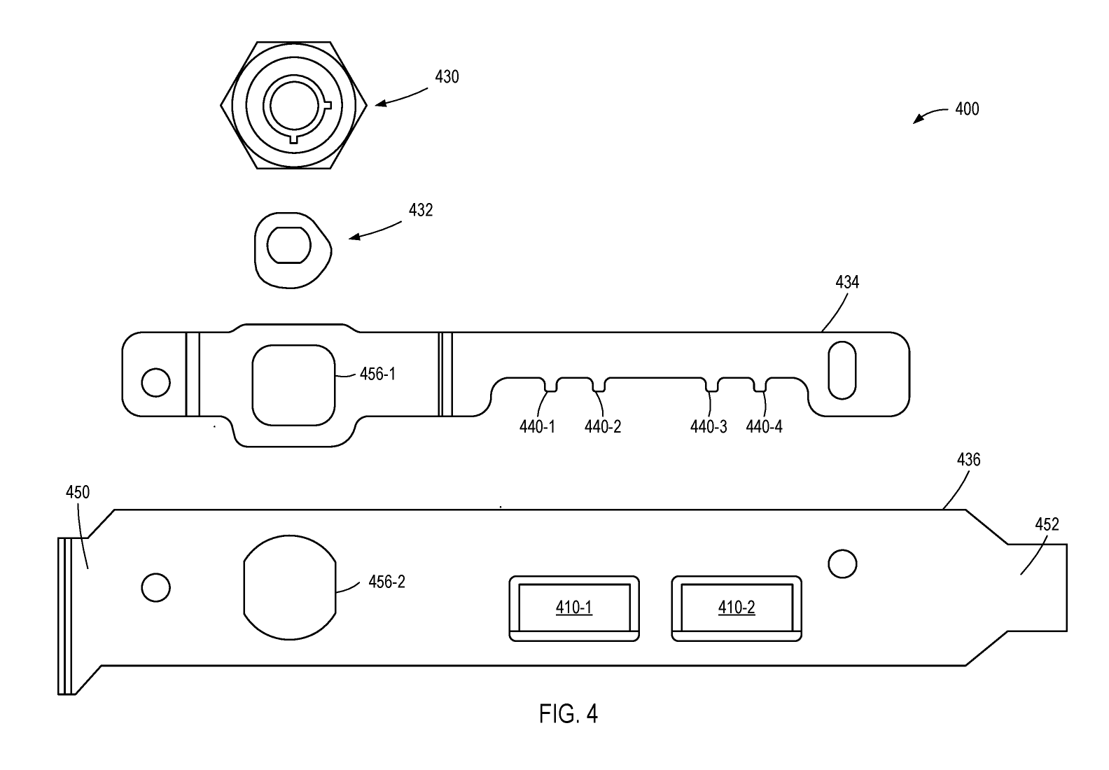

FIG. 4 is a diagram of a locking device 400 for two or more data ports according to one embodiment. In the embodiment described in FIGS. 4-8, the locking device 400 includes a lock 430, a coupler 432, a locking member 434, and a bracket 436. FIG. 4 includes a frontal view of the locking device 400 with the different components of the locking device 400 separated from each other.

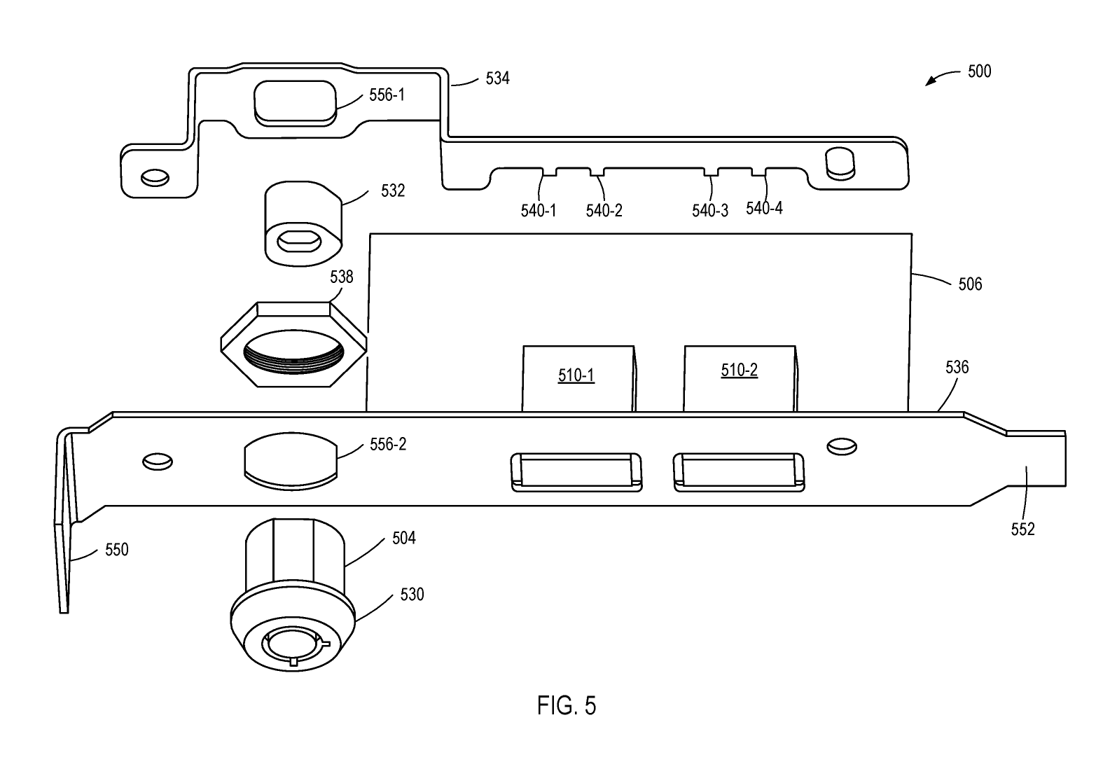

The lock 430 as shown in FIG. 4 includes a fastener (e.g., a fastener 538 in FIG. 5). The lock 430 can be configured to prevent the locking member 434 from actuating when the lock 430 is in a locked configuration.

The lock 430 can be any of a number of different types of locks. For example, the lock 430 can be a key lock, as shown in FIG. 4, or a different type of lock such as a biometric lock (e.g., not shown). Other types of locks can be utilized.

The lock 430 can be configured to be switched between a locked position and an unlocked position by turning a key. The key can be configured to function with a plurality of locks including the lock 430. That is, a key configured to operate the lock 430 can also be configured to operate one or more other locking devices.

The locking member 434 comprises at least two retention prongs 440-1, 440-2, 440-3, and 440-4 and a lock opening 456-1. The two retention prongs can be configured to retain a male connector and to exclude a male connector. The retention prongs 440-1, 440-2, 440-3, and 440-4 are referred to generally as retention prongs 440. The retention prongs 440-1 and 440-2 can be configured to retain/exclude a first male connector. The retention prongs 440-3 and 440-4 can be configured to retain/exclude a second male connector. The locking member 434 can be configured with multiples of two retention prongs such that the retention prongs 440 can retain/exclude one or more male connectors.

In some embodiments, the locking member 434 can include at least two retention prongs 440 that extend through an aperture disposed in one or more female jack (e.g., female jacks 410-1 and 410-2) of the two or more data ports when the locking member 434 is in the locked position. For example, the retention prongs 440-1 and 440-2 can be configured to extend through the aperture disposed in female jack 410-1. The retention prongs 440-3 and 440-4 can be configured to extend through the aperture disposed in female jack 410-2.

The locking member 434 can configured to move between an unlocked position and a locked position as it pivots around a shaft of the lock 430 via the lock opening 456-1. The lock opening 456-1 can also be referred to as a coupler opening 456-1. The lock 430 can be inserted through the lock opening 456-1 such that the locking member 434 can rotate around a shaft of the lock 430.

The movement of the locking member 434 can be assisted or unassisted. For example, the locking member 434 can be spring loaded to enhance the locking and/or the unlocking of the locking member 434.

In some examples, the coupler 432 can couple the lock 430 to the locking member 434. The coupler 432 can be configured to secure a shaft of the lock 430 to the locking member 434. The shaft of the lock 430 can have a profile that differs from the shape of the lock opening 456-1. The coupler 432 can bridge the difference between the profile of the lock 430 and the shape of the lock opening 456-1.

The bracket 436 can include female jacks 410-1 and 410-2, a lock opening 456-2, a tab 452, and an extension 450. The tab 452 and the extension 450 can be configured to couple the locking device 400 to a computing device. The shape of the tab 452 and/or the extension 450, as it relates to the locking device 400, may differ from those shown herein and may be configured based on the specification of a computing device to which the locking device 400 is being coupled.

When one of the male connectors is inserted into the corresponding female jack from the female jacks 410-1 and 410-2, one of the at least two retention prongs 440 extends through an aperture disposed in the male connector and the aperture disposed in the corresponding female jack when the locking member 434 is in the locked position such that the male connector cannot be removed from the corresponding female jack.

The at least two retention prongs 440 can prevent the male connectors from being inserted into the corresponding female jack when the locking member 434 is in the locked position. That is, the retention prongs 440 may extend into the female jacks 410-1 and 410-2 such that the retention prongs 440 interfere with the insertion of the male connector into the female jacks 410-1 and 410-2.

The at least two retention prongs 440 can prevent the male connectors from being retrieved from the corresponding female jack when the locking member 434 is in the locked position. In some examples, the retention prongs 440-1 and 440-2 can prevent a first male connector from being inserted into the female jack 410-1 and the retention prongs 440-3 and 440-4 can prevent a second male connector from being retrieved from the female jack 410-2 when the locking member 434 is in the locked position.

The locking member 434 can move between the unlocked position and the locked position by rotating about a pivot point that can be in the lock openings 456-1 and 456-2. For example, the lock opening 456-1 can pivot on the coupler 432 to rotate the locking member 434 around the pivot point. In some embodiments, the lock openings 456-1 and 456-2 may be different. For example, a lock opening 456-2 may be configured to secure the lock 430 such that the lock 430 does not shift. The lock opening 456-1 may be configured to fasten to a shaft of the lock 430 via the coupler 432.

FIG. 5 is a diagram of a locking device 500 for two or more data ports according to one embodiment. FIG. 5 is a frontal perspective view of the expanded components of the locking device 500. The locking device 500 is analogous to locking device 400 in FIG. 4. The locking device 500 includes a lock 530 with a shaft 504.

The locking device 500 also includes a coupler 532, a locking member 534, and a fastener 538 which are analogous to the coupler 432, the locking member 434, and the fastener 438 in FIG. 4.

The fastener 538 can be configured to couple the lock 530 to a bracket 536. In some embodiments, the fastener 538 can screw onto the shaft 504. The locking member 534 can be shaped to accommodate the length of the shaft 504 and the coupler 532. The shape of the locking member 534 can also accommodate the aperture of the female jacks 510-1 and 510-2.

The locking device 500 also includes a connector 506. The connector 506 can couple the female jacks 510-1 and 510-2 to the computing device. In some examples, the connector 506 can be inside the computing device after the locking device 500 is installed in the computing device. As previously described, the locking device 500 can be installed using an extension 550 and a tab 552. The lock 530 and/or the female jacks 510-1 and 510-2 can be external to the computing device.

For example, the locking device 500 can be coupled to an extension slot of a computing device in a permanent and/or semi-permanent manner. In some examples, the locking device 500 can be coupled to a USB port of the computing device. The locking device 500 can also be coupled to the computing device via a plug-and-play connection via the connector 506.

As previously described, the locking device 500 prevents a keylogger from being inserted between the female jack of the computing device and the male connector of a device being coupled to the computing device, when the lock is in the locked position. For example, the male connector of a device being coupled to the computing device can be coupled to one of the female jacks 510-1 and 510-2. The connector 506 can be coupled to a corresponding jack from the computing device.

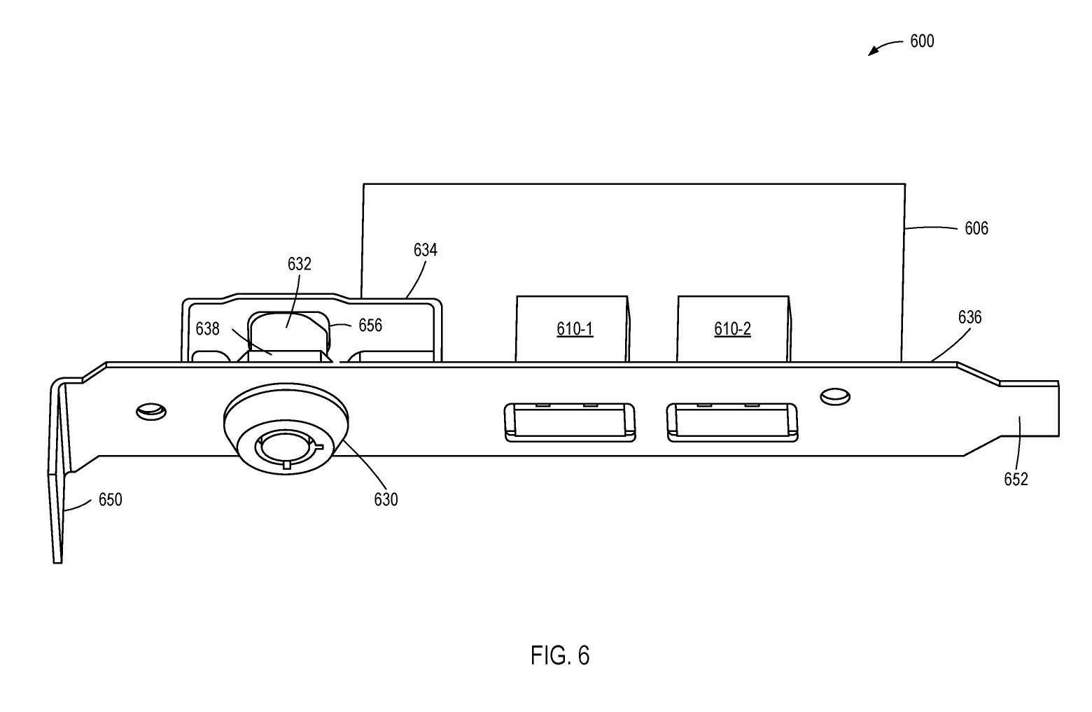

FIG. 6 is a diagram of a locking device 600 for two or more data ports according to one embodiment. FIG. 6 is a frontal perspective view of the collapsed components of the locking device 600. The locking device 600 is analogous to the locking device 400 and the locking device 500 in FIGS. 4 and 5, respectively.

In a locked position, the retention prongs (e.g., not shown) can prevent a first male connector and a second male connector from being removed from a first female jack 610-1 and a second female jack 610-2 when the lock in in the locked position.

In some examples, the female jacks 610-1 and 610-2 and/or a connector 606 can be separable from the locking device 600. In other embodiments, the female jacks 610-1 and 610-2 are permanently coupled to a bracket 636 via the at least two port openings. The bracket 636 can also be removably coupled to an extension slot of the computing device.

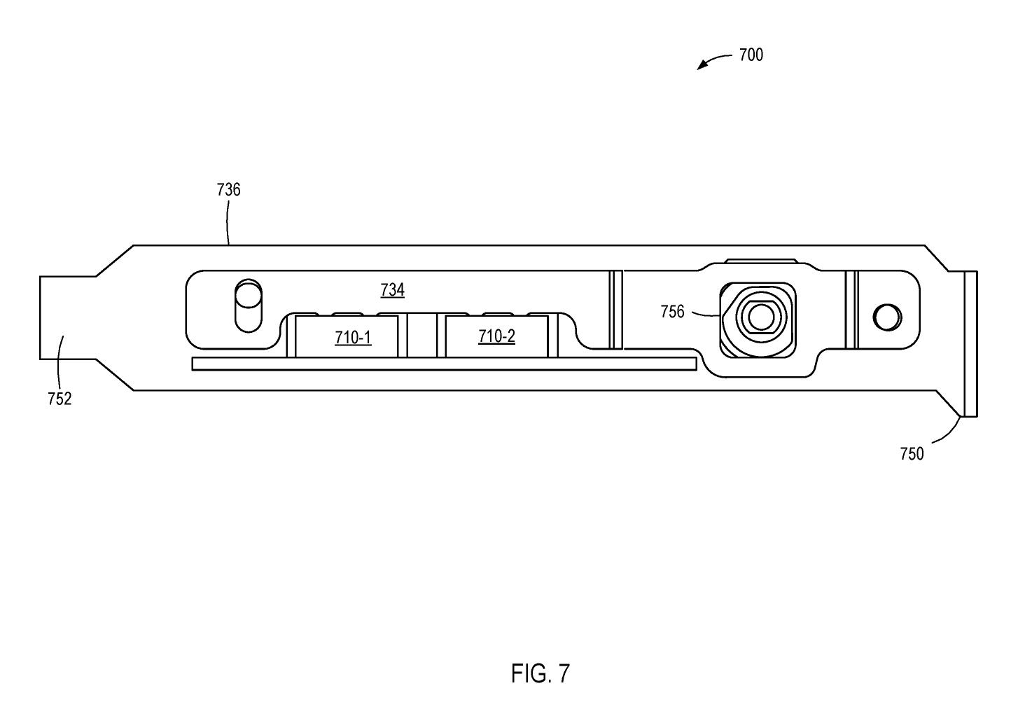

FIG. 7 is a diagram of a locking device 700 for two or more data ports according to one embodiment. FIG. 7 is a rear view of the collapsed components of the locking device 700. The locking device 700 is analogous to the locking devices 400, 500, and 600 in FIGS. 4, 5, and 6, respectively, as are the associated components of the locking device 700. FIG. 7 shows a locking member 734, a bracket 736, an extension 750, a tab 752, and a coupler opening 756.

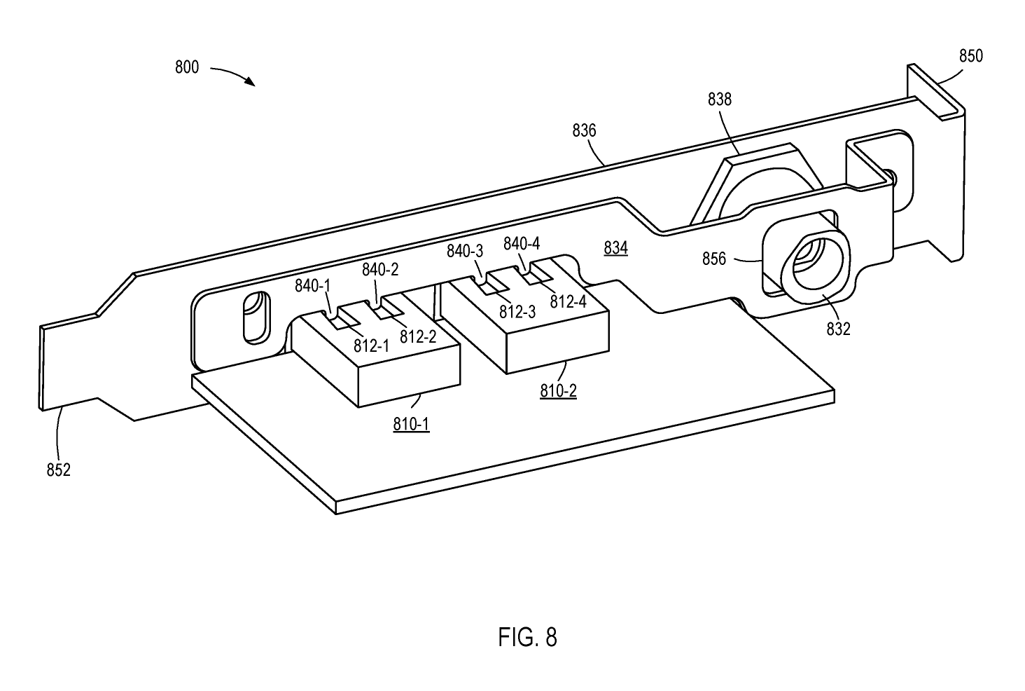

FIG. 8 is a diagram of a locking device 800 for two or more data ports according to one embodiment. FIG. 8 is a rear perspective view of the collapsed components of the locking device 800. The locking device 800 is analogous to the locking devices 400, 500, 600, and 700 in FIGS. 4, 5, 6, and 7, respectively, as are the associated components of the locking device 800. FIG. 8 shows a locking member 834, a bracket 836, an extension 850, a tab 852, and a coupler opening 856. FIG. 8 also shows female jacks 810-1 and 810-2, a coupler 832, a fastener 838, and retention prongs 840-1, 840-2, 840-3, and 840-4.

FIG. 8 also shows the holes 812-1, 812-2, 812-2, and 812-4, referred to generally as holes 812. The holes 812 are analogous holes 112 in FIG. 1.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A locking device for one or more data ports, each data port comprising a female jack configured to receive and provide an electrical connection for a male connector, the locking device comprising:
a locking member comprising one or more retention prongs, wherein:
the locking member is configured to move between an unlocked position and a locked position;
each of the one or more retention prongs extend through a corresponding aperture disposed in a female jack of the one or more data ports when the locking member is in the locked position; and
when one of the male connectors is inserted into the corresponding female jack, at least one of the one or more retention prongs extend through an aperture disposed in the male connector and the aperture disposed in the corresponding female jack when the locking member is in the locked position such that the male connector cannot be removed from the corresponding female jack.

2. The locking device of claim 1, wherein the locking member moves between the unlocked position and the locked position by rotating about a pivot point.

3. The locking device of claim 1, wherein the one or more retention prongs prevent the male connector from being inserted into the corresponding female jack when the locking member is in the locked position.

4. The locking device of claim 1, wherein the male connector is at least one of a keyboard, a mouse, a printer, a camera, and a credit card reader.

5. The locking device of claim 1, wherein the male connector is a keylogger.

6. The locking device of claim 1, wherein the male connector coupled to the female jack continues to function when the locking member is in the locked position. The locking device of claim 1, wherein the locking member is spring loaded.

8. The locking device of claim 1, wherein the locking member is manually slidable.

9. The locking device of claim 1, wherein the locking member is prevented from moving when the locking member is in a locked position.

10. A locking device for two or more data ports, the locking device comprising:
a bracket comprising;
a lock opening; and
at least two port openings;
a lock coupled to the bracket via the lock opening wherein:
the lock is configured to move between an unlocked position and a locked position;
a locking member coupled to the lock and including:
a first number of retention prongs that extend through an aperture disposed in at least one of a first male connector and a first female jack if the lock is in the locked position; and
a second number of retention prongs that extend through an aperture disposed in at least one of a second male connector and a second female jack when the lock is in the locked position.

11. The locking device of claim 10, wherein the locking device is coupled to an extension slot of a computing device.

12. The locking device of claim 10, wherein the locking device is coupled to a universal serial bus (USB) port of a computing device.

13. The locking device of claim 10, wherein the locking device prevents a keylogger from being inserted between the female jack and the male connector when the lock is in the locked position.

14. The locking device of claim 10, wherein the lock is configured to be switched between the locked position and the unlocked position by turning a key.

15. The locking device of claim 14, wherein the key is configured to switch a plurality of locks including the lock between the locked position and the unlocked position.

16. A locking device for two or more data ports, the locking device comprising:
a bracket comprising;
a lock opening; and
at least two port openings comprising at least a first female jack and a second female jack;
a lock coupled to the bracket via the lock opening wherein:
the lock is configured to move between an unlocked position and a locked position;
a coupler coupled to the lock, the coupler being configured to rotate with the lock;
the locking member coupled to the lock via the coupler and including;
a coupler opening configured to:
make contact with the coupler; and
pivot on the coupler;
a first number of retention prongs that extend through an aperture disposed in at least one of a first male connector and the first female jack when the lock is in the locked position; and
a second number of retention prongs that extend through an aperture disposed in at least one of a second male connector and the second female jack when the lock is in the locked position.

17. The locking device of claim 16, wherein the first number of retention prongs and the second number of retention prongs prevent the first male connector and the second male connector from being removed from the first female jack and the second female jack, respectively, when the lock is in the locked position.

18. The locking device of claim 16, wherein the first number of retention prongs and the second number of retention prongs prevent the first male connector and the second male connector from being inserted into the first female jack and the second female jack, respectively, when the lock is in the locked position.

19. The locking device of claim 16, wherein the first number of retention prongs and the second number of retention prongs prevent the first male connector from being removed from the first female jack and the second male connector from being inserted into the second female jack, when the lock is in the locked position.

20. The locking device of claim 16, wherein the first female jack and the second female jack are permanently coupled to the bracket via the at least two port openings.

21. The locking device of claim 18, wherein the first female jack and the second female jack are coupled to a first USB port and a second USB port of a computing device.

22. The locking device of claim 16, wherein the bracket is removably coupled to an extension slot of a computing device.
